(19) United States
(12) Patent Application Publication
(10) Pub. No.: US 2009/0026711 A1
(43) Pub. Date: Jan. 29, 2009

(54) COMPRESSION PISTON RING

(75) Inventors: Mitsuru URABE, Saitama-shi (JP); Kazuhiko Kanno, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: NIPPON PISTON RING CO., LTD., Saitama-shi (JP)

(21) Appl. No.: 12/176,672

(22) Filed: Jul. 21, 2008

(30) Foreign Application Priority Data
Jul. 27, 2007 (JP) 2007-195611

(51) Int. Cl. F02F 5/00

(52) U.S. Cl. 277/436

(57) ABSTRACT

A generally circular compression piston ring having an outer peripheral surface, an inner peripheral surface, and a pair of end faces splitting the circular shape in a radial direction thereof for defining a gap portion. The ring has a first portion including a notched portion formed at the inner peripheral surface and extending over a predetermined circumferential length portion starting from the end face, and a second portion other than the first portion. The second portion has a radial thickness ranging from 2.0 mm to 6.0 mm. The notched portion is a plane shape gradually reaching the outer peripheral surface toward the end face. The end face has a radial thickness ranging from 0.2 times to less than 0.5 times as large as the radial thickness of the second portion. The outer peripheral surface defines a center serving as a center of a center angle, and the predetermined circumferential length portion is defined by the center angle ranging from 26.5 degrees to 14 degrees.

### TECHNICAL FIELD

The present invention relates to a compression piston ring for use in an internal combustion engine, and more particularly to a low tip pressure condition compression piston ring.

### BACKGROUND

A compression piston ring is generally classified into a high tip pressure condition compression ring and a low tip pressure condition compression ring in terms of a distribution of contact pressure. The high tip pressure condition ring provides higher contact pressure at a gap portion of the ring than that at the remaining portion. The low tip pressure condition ring provides lower contact pressure at the gap portion of the ring than that at the remaining portion. Two types of ring are selectively used in light of working environment or intended function. The low tip pressure condition compression ring is generally used in a high-output type diesel engine where heavy frictional wearing may occur at the gap portion.

Attention has been drawn to a fact that a distribution of a contact pressure of the compression piston ring with respect to a cylinder bore can be changed depending upon a circumferential shape of the compression piston ring at its non-loaded condition. Based on this understanding, a conventional compression ring has a uniform cross-sectional shape in a circumferential direction thereof but has a deflected circular shape in order to obtain a desired contact pressure.

However, according to such conventional compression ring providing even contact pressure along its circumference, circumferential shape of the compression ring is largely changed due to difference in thermal expansion amount caused by temperature difference between the cylinder and the compression ring and due to thermal stress occurring in the ring caused by the temperature difference between inner peripheral surface and the outer peripheral surface of the compression ring. As a result, contacting condition between the compression ring and the cylinder bore may be changed, and particularly, contact pressure at the gap portion is increased according to an increase in operating temperature. Consequently, excessive frictional wearing occurs at the outer peripheral surface of the gap portion.

In order to solve this problem, Japanese Patent Application Publication No. 2000-120866 discloses a compression piston ring where an inner peripheral surface of the compression ring is formed with a notched portion by a predetermined circumferential length and starting from the gap portion.

A high performance engine has been provided to meet with a recent regulation as to exhaust gas and fuel consumption, so that a heat load to the engine is increased. Further, downsizing to the engine also leads to the increase in heat load. More specifically, downsizing can be attained by reducing engine displacement yet increasing engine output by a turbo-charger or supercharger concurrently realizing reduction in carbon dioxide emission and improvement on fuel consumption. However, heat load would be increased by the provision of the charging system. In view of the above, higher performance of the compression piston ring having durability against high contact pressure at the gap portion is also required. For example, output per engine displacement at present petrol engine and diesel engine is increased by 10 KW/L (litter) in comparison with that of the engine at ten years ago at which the Japanese Patent Application Publication No. 2000-120866 was originally filed.

### SUMMARY

In view of the foregoing, it is an object of the pre-sent invention to provide a compression piston ring capable of restraining increase in contact pressure at a gap portion yet being available for high performance high load engine.

This and other object of the present invention will be attained by providing a compression piston ring in a form of a generally circular shape and having an outer peripheral surface in sliding contact with a cylinder, an inner peripheral surface in confrontation with a piston, and a pair of end faces splitting the circular shape in a radial direction thereof for defining a gap portion. The compression piston ring has a first portion including a notched portion formed at the inner peripheral surface and extending over a predetermined circumferential length portion starting from the end face, and a second portion other than the first portion. The second portion has a radial thickness ranging from 2.0 mm to 6.0 mm, and the first portion has a radial thickness smaller than that of the second portion. The notched portion is a plane shape gradually reaching the outer peripheral surface toward the end face. The end face has a radial thickness ranging from 0.2 times to less than 0.5 times as large as the radial thickness of the second portion. The outer peripheral surface defines a center serving as a center of a center angle. The predetermined circumferential length portion is defined by the center angle ranging from 26.5 degrees to 14 degrees.

### BRIEF DESCRIPTION OF THE DRAWINGS

The particular features and advantages of the invention as well as other objects will become apparent from the following description taken in connection with the accompanying drawings, in which:

FIG. 1 is a partial plan view illustrating a shape of a part of a compression piston ring, the part including a gap portion according to an embodiment of the invention;

FIG. 2 is a cross-sectional view of a contact pressure measurement device for measurement of a contact pressure of the compression piston ring according to the embodiment;

FIG. 3 is a graphical representation showing contact pressure distribution of various types of compression piston rings at a cold operation temperature;

FIG. 4 is a graphical representation showing contact pressure distribution of the various type of compression piston rings at hot operating temperature;

FIG. 5 is a partial schematic perspective view showing a method for forming a notched portion in the compression piston ring according to the embodiment;

FIG. 6 is a partial plan view showing the method for forming the notched portion in the compression piston ring according to the embodiment; and

FIG. 7 is a partial plan view illustrating a shape of a part of a compression piston ring, the part including a gap portion according to a modified embodiment of the invention;

### DETAILED DESCRIPTION

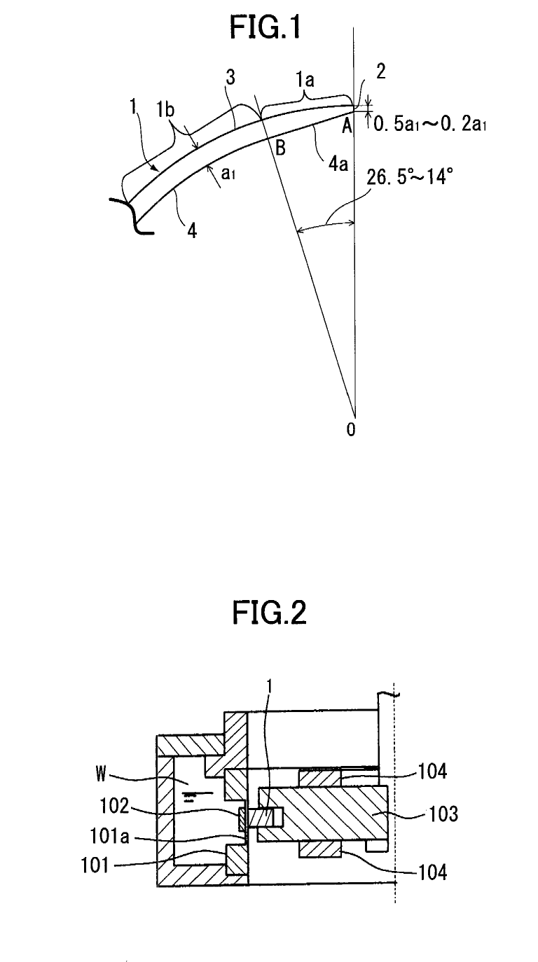

A compression piston ring according to an embodiment of the invention will be described with reference to FIGS. 1 through 5. The compression piston ring 1 is made from steel and is generally circular shape. The ring 1 has an outer peripheral surface 3 in sliding contact with a cylinder (not shown), an inner peripheral surface 4 in confrontation with a piston (not shown), and a single gap portion 2 that splits the generally circular shape along a line extending in a radial direction thereof. An entire surface of the compression piston ring 1 is subjected to gas nitriding treatment, and Cr—N group arc ion plating is formed as a high hardness cover layer at the outer peripheral surface 3. The high hardness cover layer can improve durability and wear resistance. Alternatively, Cr—B—N group arc ion plating, or diamond-like-carbon (DLC) coating is available.

A distance between the outer and inner peripheral surfaces 3 and 4, i.e., a radial thickness of the compression piston ring, is defined as “a₁”. Further, a notched portion 4a is formed at a side of the inner peripheral surface 4 over a predetermined circumferential length starting from an end face of the gap portion 2 as shown by a plane or flat region A-B in FIG. 1 so that the notched portion 4a forms a part of the inner peripheral surface. In FIG. 1, a region 1a will be referred to as a first portion, and a region 1b will be referred to as a second portion.

The radial thickness at the plane region A-B, i.e., the first region, is smaller than that at a remaining portion, i.e., the second region 1b. Incidentally, the position B is a boundary between the notched portion 4a at the predetermined circumferential length portion and a circular inner peripheral surface at the remaining portion other than the predetermined circumferential length portion.

The radial thickness at the position B and at the second portion 1b is a₁ ranging from 2.0 mm to 6.0 mm. The radial thickness is gradually reduced toward the position A at the end face defining the gap portion. The radial thickness at the position A is from 0.2 times to less than 0.5 times as large as a₁. The plane region A-B extends in a range of from 14 degrees to 26.5 degrees in terms of a center angle whose center is coincident with a center axis of the outer peripheral surface 3. This center angle is reduced in accordance with an increase in the radial thickness at the end face defining the gap portion 2.

If the center angle is less than 14 degrees, reduction range of bending rigidity in the radial direction of the compression ring is insufficient, which leads to an increase in contact pressure during engine operational phase. On the other hand, if the center angle exceeds 26.5 degrees, the notched portion 4a will become close to the outer peripheral surface 3 as a portion of the notched portion 4a is positioned away from the end face. This leads to reduction in mechanical strength causing breakage of the compression piston ring.

If the radial thickness at the position A is less than 0.2 times as large as the radial thickness a₁ at the position B, the end face defining the gap portion may be separated from a piston ring groove (not shown) and moved away from the outer peripheral surface of the piston, to thus degrade gas sealability. On the other hand, if the radial thickness at the position A is not less than 0.5 times as large as the radial thickness a₁ at the position B, reduction amount in bending rigidity is insufficient, which leads to increase in contact pressure at engine operational phase. Accordingly, enhanced gas sealability can be obtained, local frictional wear can be reduced, and cracking or peeling off the high hardness layer can be avoided at the engine operational phase by setting the radial thickness at the position A in a range from 0.2 times to less than 0.5 times as large as a₁. Identical notched portion 4a starting from another end face (not shown in FIG. 1) defining the gap portion 2 is also formed.

FIG. 2 shows a device for experiments of contact pressure of the compression piston ring. More specifically, a part of an outer peripheral surface of a cylinder 101 was engraved to provide an engraved portion 101a or thinnest portion 101, with which a strain gauge 102 was attached. Each testing sample of compression piston rings including a compression piston ring 1 according to the present embodiment and a conventional compression piston ring was assembled to a piston 103 for measuring strain due to contact load, the strain being simulated to the contact pressure. Heaters 104 were provided to upper and lower end faces of the piston 103, respectively for heating the compression piston ring. A cooling water W was applied to an outer peripheral surface of the cylinder 101 for cooling the cylinder 101. A temperature gradient distribution simulated with the distribution caused by the actual engine operation was provided from the piston 103 to the cylinder 101 by the heaters 104 and the cooling water W. The testing samples have an outer diameter of 112.0 mm, and thickness a₁ of 4.35 mm, and end faces at the gap portions had seven grades, that is, 0.2a₁ with a notched portion (sample A), 0.3a₁ with a notched portion (sample B), 0.4a₁ with a notched portion (sample C), 0.45a₁ with a notched portion (sample D), 0.5a₁ with a notched portion (Sample E), 0.6a₁ with a notched portion (sample F), and 1.0a₁ with no notched portion (sample G). The center angle of the samples A through G were 20.5°, 19.2°, 17.8°, 17.1°, 16.3°, 14.7°, 0°, respectively. These center angles were obtained by drawing a tangential line at the position B from the radially inner end of the end face that defines the gap portion. The testing samples A through D belong to the compression piston rings according to the present embodiment.

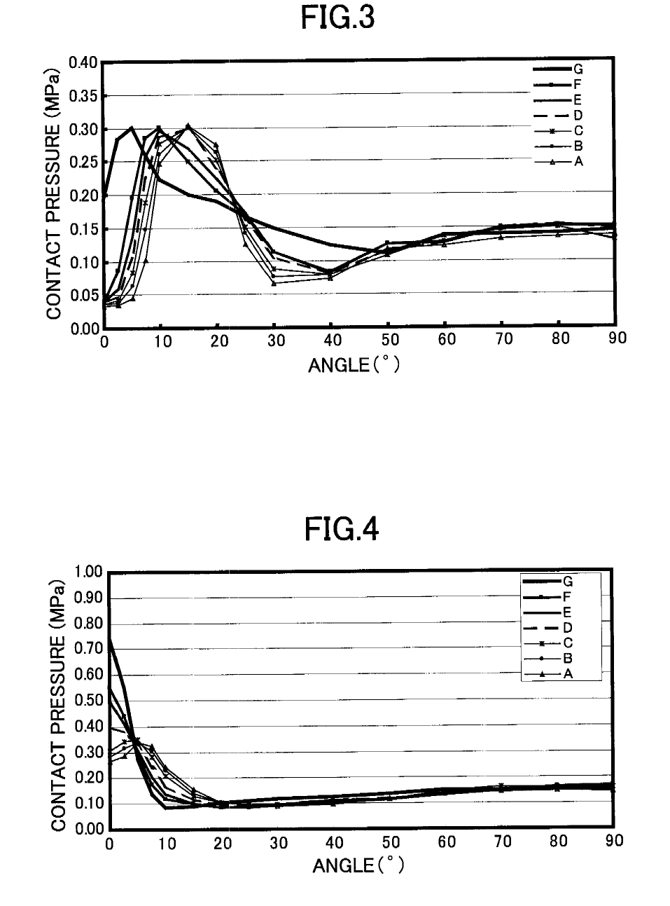

FIGS. 3 and 4 are graphical representations showing the relationship, in each testing samples A through G, between a contact pressure along an axis of ordinate and an angle from the gap portion along an axis of abscissas during cold operation temperature (FIG. 3) and hot operating temperature (FIG. 4). “Cold operation temperature” implies the temperature at which the engine has not become warmed up such as a start-up timing of the engine (about 0° C. to about 40° C.), and “hot operation temperature” implies the temperature at which the engine has become properly warmed up after engine start-up (about 200° C. to about 250° C.).

As shown in FIG. 3, at the cold operation temperature, contact pressure at the gap portion of the compression piston ring formed with the notched portion (samples A through F) is lower than that of the conventional compression piston ring (sample G) not formed with the notched portion, realizing reduction in contact pressure because of the reduction in bending rigidity. That is, at the gap portion (angle 0°), the sample G showed the contact pressure of 0.20 MPa, whereas the samples A through F showed the contact pressure of about 0.04 MPa. This means that non-contacting phenomena of the compression piston ring relative to the cylinder did not occur in the samples A through F.

As shown in FIG. 4, at the hot operation temperature, contact pressure was converged to about 0.15 MPa at the angle of 90° C. in each sample. On the other hand, contact pressure at the gap portion (angle 0°) was increased to 0.75 MPa in case of sample G, whereas the contact pressure became 0.50 MPa in case of sample E. The latter amount is still insufficient.

In case of sample D, the contact pressure became 0.4 MPa, which is almost half the contact pressure attendant to sample G. In case of samples A through C, the contact pressure became about 0.3 MPa which is lower than that of the sample D. However, reduction ratio is not remarkable in comparison with the reduction ratio of the thickness of the end face defining the gap portion. Accordingly, a thickness at the end face defining the gap portion 2 should be in a range of from 0.45a₁ to 0.2a₁, and preferably, 0.4a₁ to 0.2a₁ so as to sufficiently restrain excessive increase in surface pressure at the hot operation temperature. By selecting the above-described range, sufficient gas sealability can be provided and local frictional wear can be restrained even in current internal combustion engines where higher pressure is required.

Incidentally, in the experiments described above, the samples A through G were prepared so as to exhibit the contact pressure of about 0.15 MPa at a portion other than the gap portion at the cold operation temperature. However, various contact pressure level other than 0.15 MPa can be selected depending upon the required engine performance.

For producing the compression piston ring according to the embodiment, an end portion of a workpiece 1A is formed into an arcuate shape, and then a rotary cutter 10 such as a cutting grinding wheel is used for forming the notched portion. The rotary cutter 10 is fed along a broken line C which is a tangential line with respect to an inner peripheral surface of the curved workpiece 1A. As a result, the center angle defining an area of the notched portion can become largest, and the thickness of the end face defining the gap portion can be reduced. Instead of the rotary cutter 10, another cutting machine such as an electric discharge machine and an end mill are also available. Further, cut-off grinding is also available.

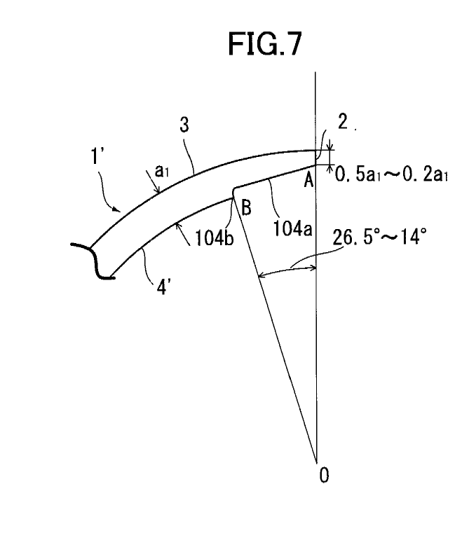

A compression piston ring 1′ according to a modified embodiment of the present invention is shown in FIG. 7. According to the modification, a stepped portion 104b is provided at a boundary between an inner peripheral surface 4′ and a notched portion 104a such that the notched portion 104a is positioned closer to an outer peripheral surface 3 than the inner peripheral surface 4′ to the outer peripheral surface 3. With this structure, radial thickness at the notched region 104a can be reduced, to thus reduce bending rigidity at the notched portion 104a. Such arrangement is particularly available for the compression ring having large radial thickness.

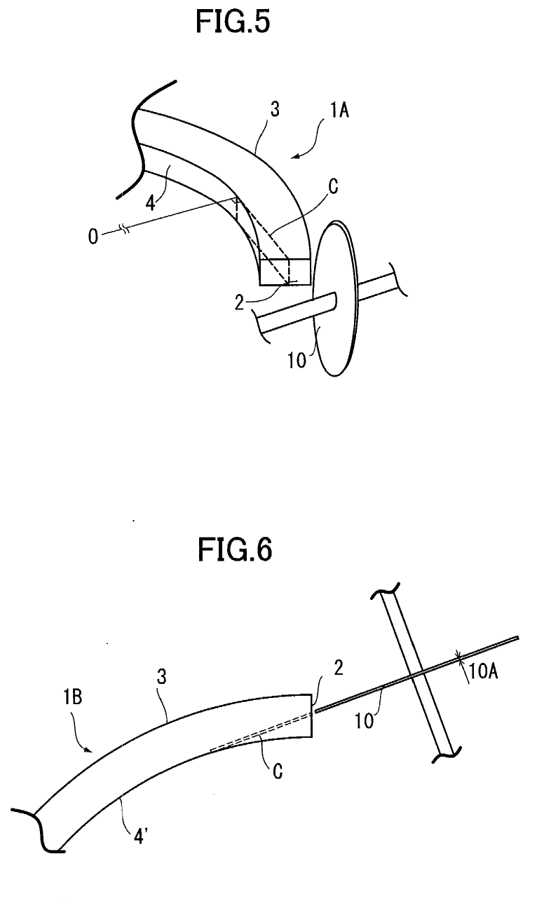

For producing the compression piston ring 1′, the rotary cutter 10 is moved along a broken line C. This line C is displaced toward the outer peripheral surface 3 by an axial thickness 10A of the grinding wheel 10 in comparison with a case shown in FIG. 5 when forming the notched portion 104a. As a result, the axial thickness 10A of the grinding wheel 10 corresponds to a depth of the notched portion 104a.

While the invention has been described in detail with reference to the embodiments thereof, it would be apparent to those skilled in the art that various changes and modifications may be made therein without departing from the spirit of the invention.

1. A compression piston ring in a form of a generally circular shape and having an outer peripheral surface in sliding contact with a cylinder, an inner peripheral surface in confrontation with a piston, and a pair of end faces splitting the circular shape in a radial direction thereof for defining a gap portion, the compression piston ring having a first portion including a notched portion formed at the inner peripheral surface and extending over a predetermined circumferential length portion starting from the end face, and a second portion other than the first portion, the second portion having a radial thickness ranging from 2.0 mm to 6.0 mm, and the first portion having a radial thickness smaller than that of the second portion;
wherein the notched portion is a plane shape gradually reaching the outer peripheral surface toward the end face, and
wherein the end face has a radial thickness ranging from 0.2 times to less than 0.5 times as large as the radial thickness of the second portion; and
wherein the outer peripheral surface defines a center serving as a center of a center angle, and the predetermined circumferential length portion being defined by the center angle ranging from 26.5 degrees to 14 degrees.

2. The compression piston ring as claimed in claim 1, wherein the center angle is reduced as the radial thickness of the end face is increased.

3. The compression piston ring as claimed in claim 1, wherein the predetermined circumferential length portion has a circumferential end positioned at a boundary of the second portion, the notched portion linearly extending along a tangential line at the boundary.

4. The compression piston ring as claimed in claim 1, wherein the predetermined circumferential length portion has a circumferential end positioned at a boundary of the second portion, a stepped portion being formed at the boundary so that the notched portion is positioned toward the outer peripheral surface.

5. The compression piston ring as claimed in claim 1, further including a high hardness layer formed over the outer peripheral surface.
